(19) United States
(12) Patent Application Publication
(10) Pub. No.: US 2025/0314127 A1
(43) Pub. Date: Oct. 9, 2025

(54) SCREEN FRAMING SYSTEM

(71) Applicants: William E. Williams, III, Garland, TX (US); Joshua Laube, Plano, TX (US)

(72) Inventors: William E. Williams, III, Garland, TX (US); Joshua Laube, Plano, TX (US)

(21) Appl. No.: 19/171,012

(22) Filed: Apr. 4, 2025

Related U.S. Application Data
(60) Provisional application No. 63/575,137, filed on Apr. 5, 2024.

(51) Int. Cl. E06B 9/52

(52) U.S. Cl. CPC E06B 9/52

(57) ABSTRACT

A screen framing system that is easily and cost-effectively shipped in a compact form, and that is configured to be easily assembled by an end-user without tools and without extensive experience in assembling such framing systems. A plurality of hollow elongate frame members, when connected to one another, provide structural rigidity for the mounting of screen fabric attached to the elongate frame members. The screen fabric has edges having a thickness greater than the thickness of the non-edge portions of the screen fabric, which are configured to slide into end openings of channels formed on the interior edges of the elongate frame member. An interlock member having an aperture configured to align with a channel of one elongate frame member, and an extending tab configured to mate with a channel of a second elongate frame member, together act to connect adjoining elongate frame members.

### CROSS-REFERENCE TO RELATED APPLICATION

This application claims priority to U.S. Provisional Patent Application No. 63/575,137, filed on Apr. 5, 2024, titled “Screen Framing System,” the complete disclosure of which is incorporated herein by reference in its entirety.

### BACKGROUND OF THE INVENTION

### Technical Field

The present invention relates generally to framing systems, and more particularly, to framing systems for screens adapted for use in connection with windows, doors, and other openings in building structures.

### Description of Related Art

Solar screens are screens that typically consist of an aluminum frame upon which is mounted a specially designed fabric configured to block approximately ninety percent (90%) of the sun's heat from penetrating windows. Solar screens, which are often mounted immediately adjacent to, and covering, exterior windows of homes and other building structures, said screen configured to block ultraviolet (UV) rays from the sun that would otherwise cause the interior temperature of a home or other building to increase. Solar screens also work to block UV rays that can discolor or destroy blinds, shutters, and carpets/rugs. Solar screens also work to help keep windows clean by preventing much of the dirt and rain that would otherwise come into contact with the windows on which the solar screen is mounted. Referring now to FIG. 1, shown is a perspective view of an embodiment of a prior art solar screen framing system. In the prior art embodiment of a solar screen depicted in FIG. 1, the solar screen (102) is mounted adjacent to an exterior facing side of an exterior window (104) that is positioned on an exterior side of a building (106) such as a house. The prior art solar screen as depicted in FIG. 1 comprises a multi-frame member rectangular aluminum frame upon which solar screen fabric is mounted. In one embodiment of the prior art solar screen, the frame of the solar screen comprises two vertically oriented frame members (108) and two horizontally oriented frame members (110) which, when the ends of the frame members are connected to one another, form an outer frame perimeter with an interior space in which the solar screen fabric (112) is mounted. In some embodiments, solar screen frames can also include one or more frame crossmembers (114) that can enhance the structural integrity of the overall solar screen frame, and also enhance the aesthetic appearance of the solar screen. In some embodiments, the solar screen fabric has a generally black color, but in other embodiments, solar screen fabric can be printed such that the fabric has a non-black appearance that in some embodiments can appear to resemble plantation shutters or other common types of aesthetically-pleasing window coverings, thereby further enhancing the aesthetic appearance of the solar screen.

There are notable drawbacks to prior art solar screen framing systems. One such drawback arises from the inherent difficulties involved in the shipping of the solar screen frames. Specifically, solar screen frames are often bulky and thus costly objects to ship to end users (in many cases, homeowners or contractors). To the extent that solar screen frames are shipped to an end-user unassembled, another drawback to prior art solar screen frames is the difficulty involved by end-users in assembling the solar screen frame members and mounting the solar screen fabric to the frame members. In some cases, assembling solar screen frames requires an end-user to utilize tools and understand sometimes hard-to-explain multi-step directions. Therefore, what is needed to address these and other drawbacks of prior art screen framing systems is a screen framing system that is easily and cost-effectively shipped in a compact form, and that is configured to be easily assembled by an end-user without tools and without extensive experience in assembling such framing systems. The inventive screen framing system disclosed herein satisfies these and other unmet needs.

### BRIEF DESCRIPTION OF THE SEVERAL VIEWS OF THE DRAWINGS

The invention will be more fully understood by reference to the following detailed description of the preferred and alternate embodiments when read in conjunction with the accompanying drawings, wherein:

FIG. 1 shows a perspective view of an embodiment of a prior art solar screen framing system;

FIG. 2A shows a perspective view of a portion of an embodiment of a vertically and horizontally oriented frame members of an embodiment of a screen framing system;

FIG. 2B shows a cross-sectional view of the portion of an embodiment of a vertically and horizontally oriented frame members of an embodiment of a screen framing system as depicted in FIG. 2A;

FIG. 2C shows a perspective view of a partially assembled embodiment of a screen framing system including vertically and horizontally oriented frame members of an embodiment of a screen framing system of the type depicted in FIG. 2A and FIG. 2B (person depicted in figure shown only for purposes of illustrating relative proportions of one embodiment of claimed invention and to illustrate assembly of components thereof);

FIG. 3A shows a perspective view of the embodiment of the screen framing system depicted in FIG. 2A-2C being further assembled (person depicted in figure shown only for purposes of illustrating relative proportions of one embodiment of claimed invention and to illustrate assembly of components thereof);

FIG. 3B shows a further perspective view of the embodiment of the screen framing system depicted in FIG. 3A being further assembled (person depicted in figure shown only for purposes of illustrating relative proportions of one embodiment of claimed invention and to illustrate assembly of components thereof);

FIG. 4A shows a perspective view of the embodiment of the screen framing system depicted in FIG. 3B being further assembled (person depicted in figure shown only for purposes of illustrating relative proportions of one embodiment of claimed invention and to illustrate assembly of components thereof);

FIG. 4B shows an exploded view of embodiments of the vertically and horizontally oriented frame members, and how they are connected together by utilizing an interlock member and elongate wedge member;

FIG. 5A shows perspective view of an embodiment of the interlock member depicted in FIG. 4B, and utilized in conjunction with an elongate wedge member, to connect together ends of a horizontally oriented frame member and vertically oriented frame member of the embodiment of the screen framing system depicted in FIG. 4A;

FIG. 5B shows side view of the embodiment of the interlock member depicted in FIG. 5A;

FIG. 5C shows a further perspective view of the embodiment of the interlock member depicted in FIG. 5A;

FIG. 6A shows a perspective view of an embodiment of the elongate wedge member depicted in FIG. 4B, and utilized in conjunction with an interlock member, to connect together ends of a horizontally oriented frame member and vertically oriented frame member of the embodiment of the screen framing system depicted in FIG. 4A;

FIG. 6B shows a top view of the embodiment of the elongate wedge member depicted in FIG. 6A;

FIG. 6C shows a side view of the embodiment of the elongate wedge member depicted in FIG. 5A;

FIG. 7A shows a perspective view of the embodiment of the screen framing system depicted in FIG. 4A being further assembled (person depicted in figure shown only for purposes of illustrating relative proportions of one embodiment of claimed invention and to illustrate assembly of components thereof); and

FIG. 7B shows a perspective view of the embodiment of the screen framing system depicted in FIG. 4A fully assembled and being held by a user (person depicted in figure shown only for purposes of illustrating relative proportions of one embodiment of claimed invention and to illustrate assembly of components thereof).

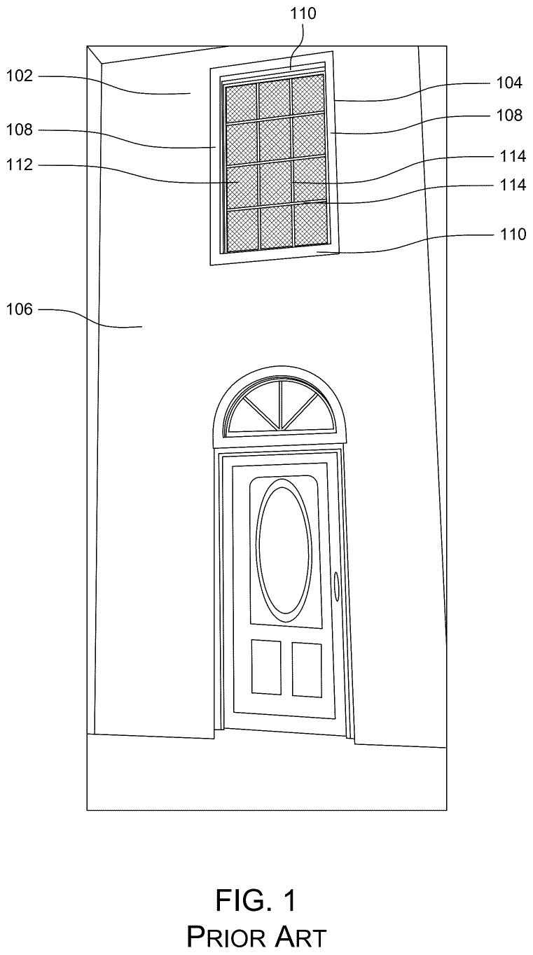

The above figures are provided for the purpose of illustration and description only, and are not intended to define the limits of the disclosed invention(s). Use of the same reference number in multiple figures is intended to designate the same or similar parts. Furthermore, if and when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the embodiments will be explained or will be within the skill of the art after the following teachings of the present invention(s) have been read and understood.

### DETAILED DESCRIPTION OF EMBODIMENTS OF THE INVENTIONS

Several exemplary embodiments of the invention(s) will now be described with reference to the drawings. Unless otherwise noted, like elements will be identified by identical numbers throughout all figures. The invention(s) illustratively disclosed herein suitably may be practiced in the absence of any element that is not specifically disclosed herein. The following description is not to be taken in a limiting sense, but is made merely for the purpose of describing the general principles of exemplary embodiments. The scope of the invention(s) should be determined with reference to the claims (if recited herein). Reference throughout this specification to “one embodiment,” “an embodiment,” or similar language means that a particular feature, structure, or characteristic described in connection with the embodiment is included in at least one embodiment of the inventions disclosed herein. Thus, appearances of the phrases “in one embodiment,” “in an embodiment,” and similar language throughout this specification may, but do not necessarily, all refer to the same embodiment. Furthermore, the described features, structures, or characteristics of the invention(s) may be combined in any suitable manner in one or more embodiments. In the following description, numerous specific details are provided, such as examples of system structures, methods of use of the systems, etc., to provide a thorough understanding of embodiments of the invention(s). One skilled in the relevant art will recognize, however, that the invention(s) can be practiced without one or more of the specific details, or with other methods, components, materials, and so forth. In other instances, well-known structures, materials, or operations are not shown or described in detail to avoid obscuring aspects of the invention(s).

Embodiments of a screen framing system are disclosed herein. It should be noted that while the exemplary embodiments of the inventions as described herein are associated with the assembly of frame members and solar screen fabric, the same principles discussed herein could be implemented in connection with mounting and securing all types of screens for mounting adjacent to windows, doors, and any other structure upon which a screen may be utilized. By way of example, the screen framing systems described herein could be utilized to assemble a screen framing system utilizing a non-solar screen fabric that is configured to be mounted adjacent to a door of a building. Numerous other ways in which the screen framing systems described herein can be utilized in connection with all manner of applications related to screen coverings will be appreciated by those with skill in the art.

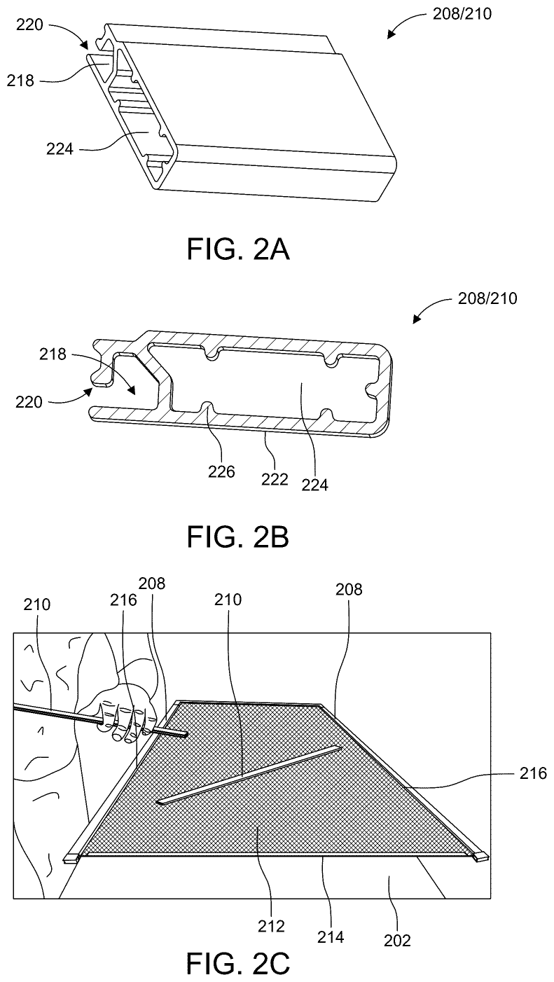

Referring now to FIG. 2C, shown is a perspective view of a partially assembled embodiment of the screen framing system (202) in which a solar screen fabric (212) is mounted to vertically oriented frame members (208), but not yet mounted to horizontally oriented frame members (210). In this unassembled configuration, the framing system may be manipulated for shipping and/or storage in a compact fashion by rolling one or both of the vertically oriented frame members about the long axis of the frame member such that the solar screen fabric (212) is also rolled together with such frame members. For shipping purposes, the two or more horizontally oriented frame members may be stored/shipped loosely (unattached to the solar screen fabric) in the same orientation as the vertically oriented frame members, thereby substantially reducing the bulkiness of the overall framing system and thus reducing associated shipping costs. In alternate embodiments, the horizontally oriented frame members may be pre-assembled/pre-attached to the solar screen fabric, while the vertically oriented frame members may be shipped/sored loosely, and may later be attached to the solar screen fabric in the same manner described below in connection with the horizontally oriented frame members. In even further alternate embodiments, all of the frame members may be shipped/stored loosely, and later be attached to the solar screen fabric in the manner described below.

It should be noted at the outset that the words “horizontally oriented” and “vertically oriented” should not be viewed by the reader as limiting in the sense that throughout this description of embodiments of the inventions, these terms are interchangeable in that in alternate embodiments, the orientations of the frame members may be reversed as compared to the descriptions and figures shown herein. For example, in alternate embodiments, the screen framing system may be configured for shipping with the horizontally oriented frame members pre-attached/pre-assembled to/with the solar screen fabric, while the steps described herein may be equally utilized to further assemble the vertically oriented frame members as part of the overall fully assembled screen framing system.

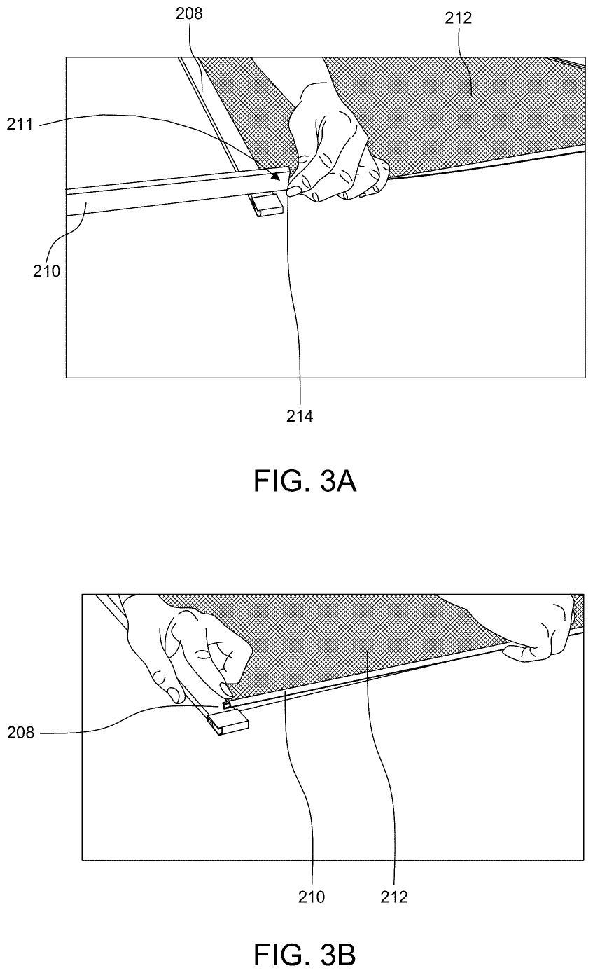

Referring now to FIG. 2A and FIG. 2B, shown is a perspective view and cross-sectional view, respectively, of a portion of an embodiment of a vertically (208) and horizontally (210) oriented frame members of the embodiment of a screen framing system depicted in FIG. 2C. FIGS. 2A and 2B depicted representative truncated sections of the vertically and horizontally oriented frame members as they appear before the insertion of an interlock member and elongate wedge member as described further below. In one embodiment of the screen framing system (202), two or more vertically oriented frame members (208) have interior edges with inwardly facing channels (218), each channel having an inwardly facing opening (220) running the length of the vertically oriented frame members (see FIG. 3 for more detailed view). The term “inwardly facing” as used herein means facing the direction of the solar screen fabric when fully assembled. Each frame member has a main body (222) configured to be positioned more distal to the solar screen fabric (as compared to the channel (218)) when the framing system is assembled. In one embodiment, a cavity (224) is formed through the main body (222) of the frame members, said cavity running the length of the frame member. The interior of the cavity may have one or more protrusions (226) formed thereon, said protrusions projecting inwardly into the cavity and being shaped and spaced within the cavity to receive and secure the interlock member and/or elongate wedge member (described in more detail below) to the respective frame members. Vertically oriented edges (216) of the solar screen fabric (212) are mounted to such channels (218) formed on the vertically oriented frame members (the “vertically oriented” edges of the fabric simply refers to the edge of the fabric that is intended for attachment to the vertically oriented frame members). In one embodiment, the vertically oriented edges (216) of the solar screen fabric and the horizontally oriented edges (214) of the solar screen fabric have zipper teeth attached thereto, the zipper teeth projecting outwardly from the perimeter of the fabric and being configured to be received by the respective channel along the length of each frame member. The zipper teeth are configured to be oriented outwardly on the solar screen fabric edges, towards the channels (218) of the frame members to which they will be mounted. The inwardly facing openings (220) of the respective channels are sized and shaped to allow the fabric extend out of the channel, and the channel opening is configured to secure the side of the solar screen fabric to the respective frame member to which it is attached. As described in more detail below, insertion of the fabric into the channel is intended to be accomplished by feeding the zipper teeth of one end of the fabric into the channel (218) starting at the end of a frame member, and then sliding the zipper teeth down the length of the channel of the frame member until the entire length of one side of the fabric is fully mounted to a frame member. In some embodiments, the vertically oriented edges of the solar screen fabric may be attached to the vertically oriented frame members using other known structures and techniques for mounting screen fabric to a frame member, while only the horizontally oriented solar screen fabric utilizes zipper teeth in the mounting of the horizontally oriented edges of the solar screen to the respective horizontally oriented frame members (210). In some embodiments, the edges of the solar screen fabric may not have zipper teeth attached thereto, but formed in an alternative manner providing for a thicker outer edge of the solar screen fabric, enabling for the secure mounting of the fabric to the channels of the respective frame members.

Referring now to FIG. 3A and FIG. 3B, shown are perspective views of the embodiment of the screen framing system depicted in FIG. 2C being further assembled. Referring specifically to FIG. 3A, to mount the horizontally oriented edges (214) of the solar screen fabric (212) to the horizontally oriented frame members (210), the zipper teeth attached to the edge of the fabric is fed into the channel of the horizontally oriented frame member at the distal end (211) of the frame member. Referring specifically to FIG. 3B, once the zipper teeth attached to the edge of the solar screen fabric are inserted into the channel (see FIGS. 2A and 2B at 218), the frame member may slide towards the opposite end of the fabric such that the edge of the fabric is mounted within the channel (218) along the length of the channel (or vice versa, the zipper teeth are pulled through the length of the channel of the frame member). The increased thickness of the zipper teeth aids in securing the fabric within the channel because it is not easily dislodged through the opening (220) in the channel.

While the embodiments of the framing systems depicted herein are constructed of a combination of rigid polymer materials and metals (such as aluminum for the frame members), it is contemplated that alternate embodiments of the framing system (or a subset of components thereof) may be constructed of other materials such as metal alloys, other types of polymers and metals, carbon fiber, biological materials (for example, wood), and other materials having sufficient rigidity/durability to adequately handle the forces imparted on the components and other structures of the systems described herein.

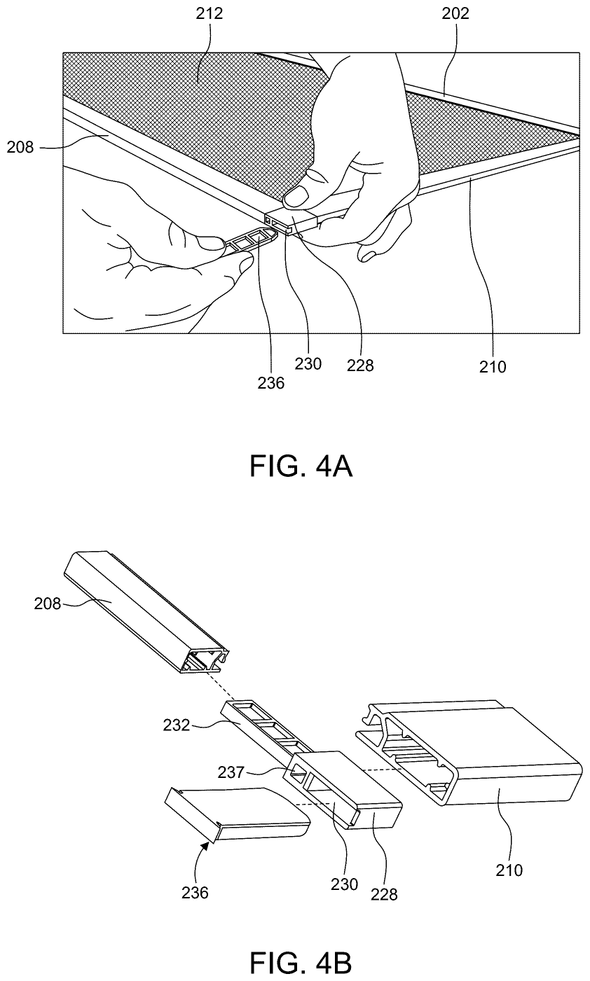

Referring now to FIG. 4A, shown is a perspective view of the embodiment of the screen framing system depicted in FIG. 3B being further assembled. In one embodiment, an interlock member (228) is configured to connect one end of a vertically oriented frame member (208) to another end of a horizontally oriented frame member (210). Thus, in most embodiments of the screen framing system that are rectangular in shape when fully assembled, four interlock members will be utilized to connect two vertically oriented frame members to two horizontally oriented frame members. In other configurations involving the assembly of more or less frame members, a greater or lesser number of interlock members will be needed to assemble the screen framing system.

Referring now to FIG. 4B, shown is an exploded view of embodiments of the vertically (208) and horizontally (210) oriented frame members, and how they are connected together by utilizing an interlock member (228) and elongate wedge member (236). Referring now to both FIG. 4A and FIG. 4B, in one embodiment the interlock member (228) includes a main body having a main first aperture (230) sized and shaped to receive all or at least a portion of an elongate wedge member (236), a distal end of said elongate wedge member being sized and shaped for insertion into the cavity (224) of the main body (222) of the horizontally oriented frame member. In another example of an alternate embodiment, the elongate wedge member may be inserted through the aperture (230) of the interlock member (228) and into the cavity of the main body of a vertically oriented frame member.

Still referring to FIG. 4A and FIG. 4B, in one embodiment, an elongate tab (232) protrudes outwardly from the main body of the interlock member. In one embodiment, the elongate tab (232) is sized and shaped for insertion into the cavity of the main body of an adjacent end of a vertically oriented frame member (208). FIG. 4A illustrates a user just prior to inserting a distal end of an elongate wedge member (236) into the aperture (230) of the interlock member (228). In one embodiment, the elongate wedge member is tapered in its width at least a portion of a length of the wedge member from a distal end to a proximal end, and the elongate wedge member is also tapered in terms of thickness from at least a portion of the length of the wedge member from its distal end to its proximal end. As the elongate wedge member is inserted by a user into the aperture (230) of the interlock member, then further inserted through the distal opening of the aperture of the interlock member and into the cavity of the main body of the end of the horizontally oriented frame member, the tapered structure of the elongate wedge member works to both align the horizontally oriented frame member with the interlock member, and also to pull taut the solar screen fabric attached to the channel of said horizontally oriented frame member. In one embodiment, a second smaller aperture (237) is formed through the interlock member for the purpose of ensuring that the interlock member has a constant wall thickness for molding the interlock member in order to prevent warping. In other alternate embodiments, when the interlock member is manufactured by alternate means other than molding (for example, by machining), the second smaller aperture (237) may be omitted.

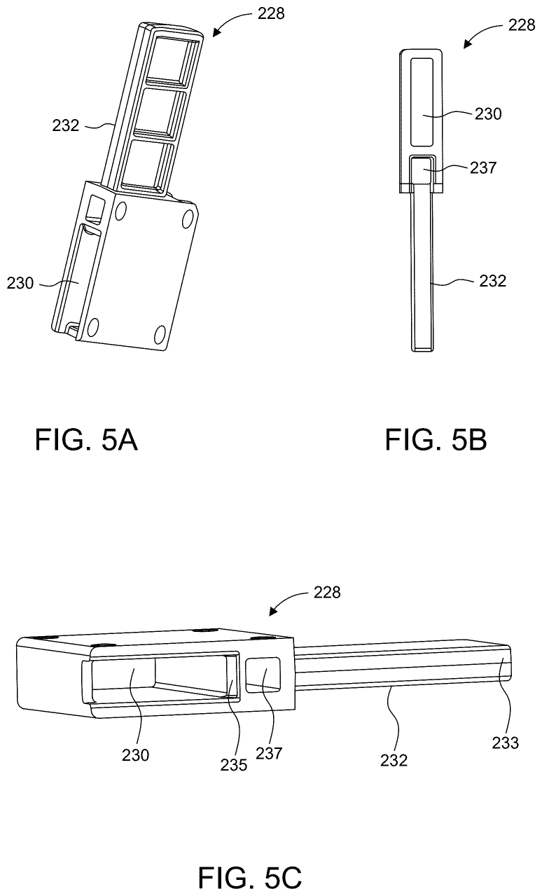

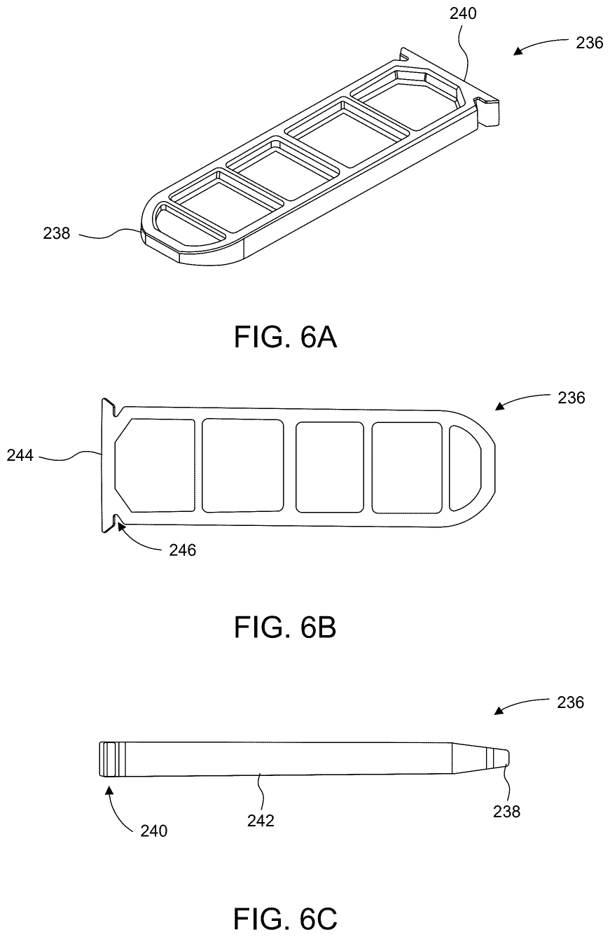

Referring now to FIG. 5A, FIG. 5B, and FIG. 5C, shown are a perspective view, a side view, and a further perspective view, respectively, of an embodiment of the interlock member (228) utilized to connect together ends of a horizontally oriented frame member and vertically oriented frame member. In one embodiment, the elongate tab (232) of the interlock member has a smaller cross-sectional area as compared to the main body housing the larger first aperture (230) and the smaller second aperture (237) formed completely through said main body. The proportionality, shapes, and dimensions of the components of the framing system taught herein may be varied depending on the application and the respective sizes and shapes of the frame members and other components of the framing system. It should be noted that while the sides of the elongate tab (232) depicted in FIG. 5A are segmented, in alternate embodiments such segmentation may not be present. In one embodiment, one or more notches (235) may be formed adjacent to the proximal opening of the first larger aperture (230), said notches (235) being configured to engage corresponding protrusions and notches formed adjacent to, or at least partially forming a handle position at or adjacent to the distal end of the wedge member (see FIG. 6B at 246) to aid in securing the wedge member within the first aperture (230) of the interlock member.

Referring now to FIG. 6A, FIG. 6B. and FIG. 6C, shown is a perspective view, a top view, and a side view, respectively, of an embodiment of the elongate wedge member (236) which, in conjunction with the interlock member (228), are utilized to connect together ends of a horizontally oriented frame member and vertically oriented frame member. In one embodiment, the elongate wedge member comprises a distal end (238), a proximal end (240), and a main body formed therebetween (242). In one embodiment, the elongate wedge member is tapered in its width from at least a portion of a length from its distal end to proximal end, and the elongate wedge member is also tapered in terms of thickness from at least a portion of a length from its distal end to its proximal end. In some embodiments, only the width or thickness of the wedge member is tapered. As the elongate wedge member is inserted by a user into the aperture (230) of the interlock member, and then through the distal opening of the aperture of the interlock member and into the cavity of the main body of the end of the horizontally oriented frame member, the tapered structure of the elongate wedge member works to both align the horizontally oriented frame member with the interlock member, and to pull taut the solar screen fabric attached to the channel of said horizontally oriented frame member. In one embodiment, a generally “T” shaped handle (244) is formed at the proximal end (240) of the elongate wedge member (236), although it is contemplated that other shapes may be utilized to construct a handle in alternate embodiments of the wedge member. The handle (244) aids a user in inserting, and in some cases, removing the wedge member into and out of the interlock member. Notches (246) are formed in the sides of the wedge member, adjacent to the handle, said notches and other portions of the handle being configured to engage corresponding notch structures within the first large aperture of the interlock member as described above. It should be noted that while the sides of the elongate wedge member (236) depicted in FIG. 6A and FIG. 6B are segmented, in alternate embodiments such segmentation may not be present.

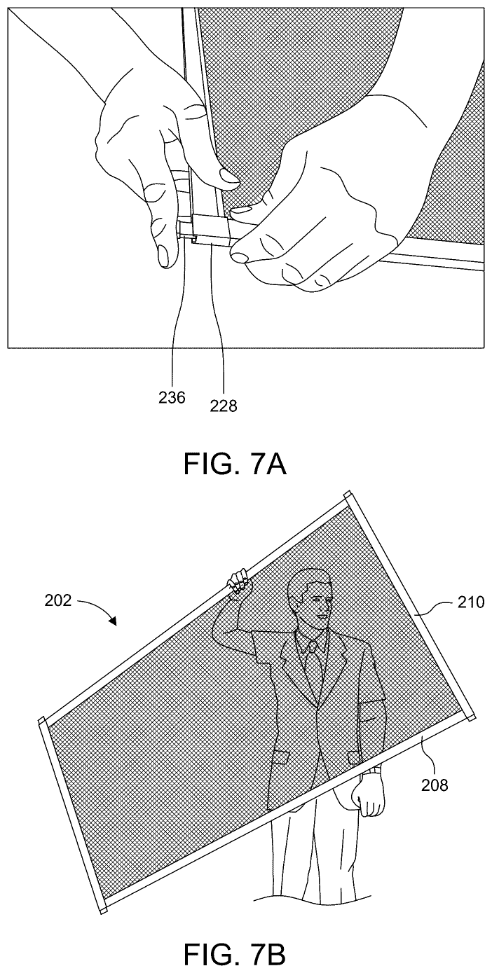

Referring now to FIG. 7A, shown is a perspective view of the embodiment of the screen framing system depicted in FIG. 4A being further assembled. FIG. 7B shows a perspective view of the embodiment of the screen framing system depicted in FIG. 4A fully assembled and being held by a user. Following the connection of the four corners of the screen framing system using interlock members and elongate wedge members to connect the vertically oriented frame members to the horizontally oriented frame members, the screen framing system is fully assembled and ready for mounting adjacent to a window (covering a window). It should be noted that the proximal end (240) of the elongate wedge member (236) depicted in FIG. 7A and FIG. 7B protrudes well beyond the edge of the interlock member and the adjacent vertically oriented frame member which, in some circumstances, may be advantageous in that it allows a user to more easily grasp the wedge member for insertion or removal from the interlock member. However, in other alternate embodiments, the proximal end of the wedge member, when the wedge member is fully inserted into the interlock first large aperture and frame member, will be flush with the end of the interlock member or only slightly protruding therefrom.

Disclosed herein, in one embodiment, is a screen framing system comprising a first elongate frame member (208) having a first cavity (224) formed within at least a portion of a first length of said first elongate frame member, said first cavity having a first opening formed on a first end of said first elongate frame member; a second elongate frame member (210) having a second cavity (224) formed within at least a portion of a second length of said second elongate frame member, said second cavity having a second opening formed on a second end of said second elongate frame member; a hollow interlock member (228) having a main body with an aperture (230) formed through said main body of said hollow interlock member, and also having an elongate tab (232) formed on and extending away from said main body; and an elongate wedge member (236) having a distal end (238) configured for removable attachment to said aperture (230) of said hollow interlock member and said second opening of said second cavity, wherein a distal end of said elongate tab is configured for removable attachment to said first opening of said first cavity of said first elongate frame member, and wherein each of said first elongate frame member and said second elongate frame member have a respective channel formed along at least a portion of a respective interior edge of said first elongate frame member and said second elongate frame member. The disclosed screen framing system further comprises a flexible screen member (212), said flexible screen member having at least a first edge (214) and a second edge (216), wherein said first edge of said screen member is configured to be removably attached to said respective channel (218) formed on said first elongate frame member, and wherein said second edge of said screen member is configured to be removably attached to said respective channel formed on said second elongate frame member. In one embodiment, each of said respective channels has a channel width, and wherein each of said respective channels has a channel opening (220) with an opening width that is less than said channel width. In one embodiment, the flexible screen member has a non-edge thickness, and wherein said first edge and said second edge of said flexible screen member each have an edge thickness that is greater than said thickness of said non-edge thickness. In one embodiment, zipper teeth are attached to said first edge and said second edge of said flexible screen member. In one embodiment, the edge thickness is greater than said channel opening. In one embodiment, the elongate wedge member has a width, along at least a portion of a length of said elongate wedge member, that tapers in thickness. In one embodiment, the elongate wedge member has a thickness, along at least a portion of a length of said elongate wedge member, that is tapered. In one embodiment, the flexible screen member comprises a flexible solar screen fabric. In one embodiment, the screen framing system includes a third elongate frame member having a third cavity formed within at least a portion of a third length of said third elongate frame member, said third cavity having a third opening formed on a third end of said third elongate frame member, and a fourth elongate frame member having a fourth cavity formed within at least a portion of a fourth length of said fourth elongate frame member, said fourth cavity having a fourth opening formed on a fourth end of said fourth elongate frame member.

The screen framing system disclosed herein is easily and cost-effectively shipped in a compact form, and that is configured to be easily assembled by an end-user without tools and without extensive experience in assembling such framing systems. A plurality of hollow elongate frame members, when connected to one another, provide structural rigidity for the mounting of screen fabric attached to the elongate frame members. The screen fabric has edges having a thickness greater than the thickness of the non-edge portions of the screen fabric, which are configured to slide into end openings of channels formed on the interior edges of the elongate frame members, the increased thickness of the screen edges preventing the fabric from being easily dislodged. An interlock member having an aperture configured to align with a channel of one elongate frame member, and an extending tab configured to mate with a channel of a second elongate frame member, together act to connect adjoining elongate frame members.

The screen framing system inventions disclosed herein may be embodied in other specific forms without departing from the spirit or essential characteristics thereof. The present embodiments are therefore to be considered in all respects as illustrative and not restrictive. All changes that come within the meaning and range of equivalency of the claims are embraced therein.

We claim:

1. A screen framing system comprising:
a first elongate frame member having a first cavity formed within at least a portion of a first length of said first elongate frame member, said first cavity having a first opening formed on a first end of said first elongate frame member;
a second elongate frame member having a second cavity formed within at least a portion of a second length of said second elongate frame member, said second cavity having a second opening formed on a second end of said second elongate frame member;
a hollow interlock member having a main body with an aperture formed through said main body of said hollow interlock member, and also having an elongate tab formed on and extending away from said main body; and
an elongate wedge member having a distal end configured for removable attachment to said aperture of said hollow interlock member and said second opening of said second cavity,
wherein a distal end of said elongate tab is configured for removable attachment to said first opening of said first cavity of said first elongate frame member,
wherein each of said first elongate frame member and said second elongate frame member have a respective channel formed along at least a portion of a respective interior edge of said first elongate frame member and said second elongate frame member.

2. The screen framing system of claim 1, further comprising a flexible screen member, said flexible screen member having at least a first edge and a second edge, wherein said first edge of said screen member is configured to be removably attached to said respective channel formed on said first elongate frame member, and wherein said second edge of said screen member is configured to be removably attached to said respective channel formed on said second elongate frame member.

3. The screen framing system of claim 2, wherein each of said respective channels has a channel width, and wherein each of said respective channels has a channel opening with an opening width that is less than said channel width.

4. The screen framing system of claim 3, wherein said flexible screen member has a non-edge thickness, and wherein said first edge and said second edge of said flexible screen member each have an edge thickness that is greater than said thickness of said non-edge thickness.

5. The screen framing system of claim 4, wherein zipper teeth are attached to said first edge and said second edge of said flexible screen member.

6. The screen framing system of claim 4, wherein said edge thickness is greater than said channel opening.

7. The screen framing system of claim 1, wherein said elongate wedge member has a width, along at least a portion of a length of said elongate wedge member, that tapers in thickness.

8. The screen framing system of claim 1, wherein said elongate wedge member has a thickness, along at least a portion of a length of said elongate wedge member, that is tapered.

9. The screen framing system of claim 2, wherein said flexible screen member comprises a flexible solar screen fabric.

10. The screen framing system of claim 1, further comprising a third elongate frame member having a third cavity formed within at least a portion of a third length of said third elongate frame member, said third cavity having a third opening formed on a third end of said third elongate frame member, and a fourth elongate frame member having a fourth cavity formed within at least a portion of a fourth length of said fourth elongate frame member, said fourth cavity having a fourth opening formed on a fourth end of said fourth elongate frame member.
